(19) United States
(12) Patent Application Publication
(10) Pub. No.: US 2022/0039924 A1
(43) Pub. Date: Feb. 10, 2022

(54) SUPERSTRUCTURE, DENTAL IMPLANT AND DENTAL PROSTHESIS

(71) Applicant: TRI Dental Implants Int. AG, Huenenberg (CH)

(72) Inventors: Sandro VENANZONI, Zürich (CH); Rafael PEREZ, Freiburg (DE); Holger KAST, Huenenberg (CH); Ronald JUNG, Herrliberg (CH)

(21) Appl. No.: 17/507,098

(22) Filed: Oct. 21, 2021

Related U.S. Application Data
(63) Continuation of application No. PCT/EP2020/055171, filed on Feb. 27, 2020.

(30) Foreign Application Priority Data
May 6, 2019 (DE) 10 2019 111 699.6

(51) Int. Cl. A61C 8/00

(52) U.S. Cl. CPC A61C 8/0051; A61C 8/0066; A61C 8/0022; A61C 8/0069; A61C 8/0077; A61C 8/0068

(57) ABSTRACT

Superstructure and dental implant each with an interface that allows direct attachment of the superstructure to the dental implant without the use of an abutment and can be manufactured in a cost-effective manner.

### CROSS REFERENCE TO RELATED APPLICATIONS

This application is a continuation of international patent application PCT/EP2020/055171, filed on Feb. 27, 2020 designating the U.S., which international patent application has been published in German language and claims priority from German patent application DE 10 2019 111 699.6, filed on May 6, 2019. The entire contents of these priority applications are incorporated herein by reference.

### BACKGROUND

This disclosure relates to a superstructure and a dental implant for use in a dental prosthesis. Furthermore, the disclosure relates to a dental prosthesis comprising the superstructure and the dental implant.

The term “superstructure” refers to a denture attached to a dental implant. This can be, for example, an artificial dental crown (also called “implant crown”), a bridge or any other prosthetic or artificial dental structure.

The term “dental implant” is often colloquially used inconsistently and often erroneously for the overall structure of a dental prosthesis. Therefore, it should be clarified at this point that a “dental implant” in the medical and present sense is understood to mean only the implant body, i.e. the artificial tooth root that is implanted in the patient's jaw. Therefore, the term “implant body” is often used instead of the term “dental implant”. In the following, however, the term “dental implant” is uniformly used for the aforesaid part of the dental prosthesis.

In addition to the dental implant and the superstructure, conventional dental prostheses comprise a so-called abutment, which acts as a connecting part between the dental implant and the superstructure. The abutment forms the sensitive transition through the peri-implant soft tissue to the oral cavity and the superstructure. Such abutments are sometimes referred to as “pillars” or “implant posts”. Commonly, abutments are made of titanium, ceramic or ceramic composites such as aluminum oxide ceramic or zirconium dioxide ceramic.

The superstructure, i.e. the artificial dental crown, is typically made of ceramic or a comparable material. Traditionally, the superstructure is made by a dental technician as follows: First, a wax model is created for the artificial dental crown. Then, the wax model is used to cast the artificial dental crown. The abutment is manually ground to the correct size and shape, and in the final step the cast artificial dental crown is mounted on the abutment. In most cases, the assembly is performed by bonding the superstructure to the abutment. This largely manual process allows highly precise results to be achieved. However, it goes without saying that this is time-consuming and therefore also cost-intensive. Additionally, there is an adhesive gap between the superstructure and the abutment, which gap is susceptible to leaks and can also limit the durability of the dental prosthesis.

Nowadays, there are many efforts to digitize or automate the above-mentioned process as far as possible. The superstructure is now often milled on a milling machine using a 3D model. In this type of fabrication, the connection geometry for the connection with the abutment is directly introduced into the superstructure on its rear side. The shape and size of the abutment must therefore already be known during the fabrication of the artificial dental crown in order to be able to program the milling machine accordingly. This is usually done by means of a CAD model of the abutment, which is read into the control system of the milling machine.

Sine the shape and size of the abutment must be known before fabricating the superstructure, many manufacturers choose a short and small abutment that fits any anatomy. However, with elongated, i.e. comparatively long superstructures, a short and small abutment is biomechanically unsuitable in relation to the superstructure, which may result in loosening or fractures.

Other manufacturers solve this by using many different abutments. Depending on the shape and size of the superstructure, abutments of different sizes or shapes are then used. For example, a different abutment has to be used for an artificial incisor than for an artificial molar tooth. If, for example, the rear flank of the abutment is not beveled when used for an artificial incisor, the abutment would be visible on the rear side of the superstructure, which is undesirable from a purely esthetic point of view. However, this problem may not arise when used for an artificial molar tooth.

In automated fabrication with digital CAD models the manufacturer of the superstructure is usually provided with several CAD data sets that represent the different shapes of the abutments. At the same time, the manufacturer of the superstructure has to keep a large number of abutments of different shapes and sizes in stock. This is often cumbersome and also generates high storage costs.

The disadvantages of the previous approaches can thus be summarized as follows: On the one hand, the use of abutments restricts the freedom of shape and design of the superstructure including its transgingival portion. A non-flexible transgingival portion of the superstructure can cause problems, particularly with soft tissue management. However, ideal soft-tissue management is crucial for an esthetic result and a long-term stable bone level. On the other hand, the material and manufacturing costs for such a dental prosthesis according to the prior art are relatively high. In addition, there is an adhesive gap between the superstructure and the abutment, which gap is disadvantageous in many respects.

### SUMMARY

It is an object to provide a superstructure and a dental implant that can be connected to each other without the use of an abutment.

According to a first aspect, a superstructure is presented, comprising an opening extending along a longitudinal axis of the superstructure and an interface for attaching the superstructure to a dental implant. The interface is configured as an extension disposed on a lower side of the superstructure, surrounding the opening and having a cylindrical or conical lateral surface that forms an outer surface of the extension. The lateral surface is interrupted by a recess that opens into the opening.

The interface arranged on the lower side of the superstructure enables the superstructure to be attached directly and immediately to the dental implant without the use of an abutment. Due to the special design of the interface, the superstructure can be arranged on the dental implant in a clearly defined manner. This enables a clearly defined relative position between the superstructure and the dental implant.

The interface features an extension that protrudes downwards from the superstructure, i.e. the artificial dental structure. This extension can be inserted into an opening provided for this purpose in the dental implant, which opening is adapted as a counterpart to the shape of the extension. The extension has a cylindrical or conical lateral surface surrounding the opening that extends through the superstructure along the longitudinal axis of the superstructure. Thus, the extension extends around said opening and preferably also extends along the longitudinal axis of the superstructure. The cylindrical or conical lateral surface forms an outer side of the extension which, on the one hand, surrounds the extension in the circumferential direction and, on the other hand, extends parallel to the longitudinal axis (in the case of a cylindrical lateral surface) or at an acute angle relative to the longitudinal axis (in the case of a conical lateral surface).

A recess is introduced laterally into the extension which recess interrupts the cylindrical or conical lateral surface and opens into the central opening of the superstructure. The recess thus extends through a part of the lateral wall of the extension, so that at one position the lateral wall of the extension is interrupted by the recess. Thus, there is preferably a hole in the lateral wall of the extension which hole extends from the outside to the central opening.

This recess serves as an anti-rotation element that prevents rotation about the longitudinal axis of the superstructure relative to the dental implant. An anti-rotation element adapted to the shape of the recess can engage in this recess and is arranged on the dental implant.

The cylindrical or conical lateral surface of the extension serves as a radial abutment surface of the superstructure on the dental implant, which radial abutment surface absorbs forces in the radial direction. In the case of a conical lateral surface, it can also serve as an axial abutment surface that absorbs forces parallel to the longitudinal axis of the superstructure.

An advantage of the described shape of the interface arranged on the superstructure is that it not only enables a direct connection of the superstructure to the dental implant, which ensures a high force absorption and is thus extremely stable from a mechanical point of view and prevents the superstructure from rotating about the longitudinal axis relative to the dental implant, but also that this interface can be produced relatively easily and thus inexpensively by means of a milling machine. The cylindrical or conical lateral surface of the extension can be readily produced by means of a ball milling cutter, which is typically used for the production of the superstructure. The insertion of the recess into the lateral surface is also no problem. This can also be easily introduced into the extension by means of a ball milling cutter. The interface can therefore be fabricated automatically in a few steps using the tools typically used for fabricating the superstructure.

According to a refinement, the recess is arranged in a region of a lower free end of the extension and is open downwards towards the lower free end. The recess is thus preferably not a closed hole or a closed bore, but a recess which is open on one side towards the bottom. The recess can therefore in principle also be described as a groove-shaped recess.

The opening of the recess on its lower side provides the advantage that it can be easily placed on the anti-rotation element arranged on the dental implant when mounting the superstructure on the dental implant. The assembly of the superstructure on the dental implant is therefore very simple.

According to a further refinement, the recess is configured as a tunnel-like recess. In other words, it has a cross-sectional shape similar to the cross-sectional shape of a tunnel, but without a bottom surface, since the recess is preferably open towards the bottom, as already mentioned.

According to a further refinement, the recess comprises two planar drive surfaces extending parallel to each other. These planar drive surfaces preferably abut on equivalently shaped, planar, parallel drive surfaces arranged on the anti-rotation element of the dental implant. They serve to absorb forces in the circumferential direction and prevent twisting or torsion of the superstructure about the longitudinal axis relative to the dental implant.

In a refinement, each of the two planar drive surfaces extends parallel to a radial direction that is oriented orthogonally to the longitudinal axis. Such an alignment enables a large force transmission of the forces acting in the circumferential direction between the superstructure and the dental implant. Due to the aforementioned alignment, the drive surfaces can also be produced very easily by milling.

According to a further refinement, the recess further comprises a concave abutment surface. This concave abutment surface preferably extends parallel to a radial direction that is oriented orthogonally to the longitudinal axis.

The concave abutment surface of the recess preferably abuts on a concave abutment surface formed as a counterpart thereto, which is provided on the anti-rotation element of the dental implant. It essentially serves to transmit force in the axial direction, i.e. parallel to the longitudinal axis.

In a refinement, the concave abutment surface provided in the recess is a cylindrical surface which is semicircular when viewed in cross-section. This again serves, on the one hand, for a simple manufacture and, on the other hand, improves the mechanical stability of the junction between the recess arranged on the superstructure and the anti-rotation element arranged on the dental implant.

According to a further refinement, the planar drive surfaces each adjoin the concave abutment surface and are arranged opposite to one another. The two planar drive surfaces therefore adjoin the concave abutment surface on opposite sides.

In a refinement, a first side edge of each of the planar abutment surfaces adjoins the concave abutment surface, whereas a second, opposite side edge of each of the planar abutment surfaces adjoins the lower free end of the extension.

According to a further refinement, the opening extends centrally through the extension. The lateral surface of the extension is therefore, except for the recess, preferably symmetrical about the longitudinal axis.

According to a further refinement, the extension is mirror-symmetrical to a longitudinal sectional plane in which the longitudinal axis lies and which divides the recess into two halves of equal size. The recess including its concave abutment surface and the two planar drive surfaces is therefore preferably mirror-symmetrical with respect to said longitudinal sectional plane as well.

According to a further refinement, the extension comprises at its lower free end an annular bearing surface that is interrupted by the recess and is oriented transversely, preferably orthogonally, to the longitudinal axis.

The annular bearing surface does not necessarily have to be oriented orthogonally to the longitudinal axis, it can also run transversely to it. In the present context, “transversely” is understood to mean any type of orientation which is not parallel. In a refinement, the annular support surface has all around a constant angle with respect to the longitudinal axis of the superstructure. In a refinement, this angle is greater than 60°.

Particularly in the case of a cylindrical configuration of the lateral surface of the extension, the annular bearing surface serves as an axial bearing surface, which enables a force transmission between the superstructure and the dental implant parallel to the longitudinal axis. In the case of a conical configuration of the lateral surface of the extension, however, the axial forces can also be transmitted via the lateral surface, as already mentioned above, so that the superstructure does not necessarily have to rest with the said annular bearing surface on a corresponding counter surface on the dental implant.

According to a further refinement, the superstructure comprises an artificial denture (for example, an artificial dental crown or bridge) that is integrally connected to the interface, wherein the opening extends through the extension into the artificial denture. The upper end of the extension is preferably integrally connected to the artificial denture. The oppositely arranged lower free end of the extension projects downwardly from the artificial denture.

According to a second aspect, a dental implant is presented, comprising an external thread arranged on an outer side of the dental implant for fastening the dental implant to a jaw bone, an opening extending along a longitudinal axis of the dental implant in which an internal thread is arranged for fastening a superstructure to the dental implant, and an interface for fastening the superstructure to the dental implant. The interface is arranged in a region of a front end of the dental implant and comprises a cylindrical or conical inner lateral surface arranged in the opening, at least partially surrounding the longitudinal axis and interrupted by an anti-rotation element that is configured to prevent rotation of the superstructure about the longitudinal axis relative to the dental implant, wherein the anti-rotation element projects radially inwards from the inner lateral surface. The interface arranged in the region of the upper free end of the dental implant is configured as a counterpart to the above-mentioned interface arranged in the region of the lower free end of the superstructure. The advantages mentioned above with regard to the interface of the superstructure thus also result in an equivalent manner with regard to the interface arranged on the dental implant.

The anti-rotation element belonging to the interface on the dental implant is equivalent or a counterpart to the recess arranged at the interface of the superstructure.

According to a refinement, the anti-rotation element comprises two planar drive surfaces extending parallel to each other.

In a further refinement, the two planar drive surfaces extend parallel to a radial direction of the dental implant, which radial direction is oriented orthogonally to the longitudinal axis of the dental implant.

As a counterpart to the concave abutment surface of the recess arranged on the superstructure, the anti-rotation element preferably comprises a correspondingly convex abutment surface. In a refinement, this convex abutment surface extends parallel to the radial direction of the dental implant (orthogonal to the longitudinal axis).

The planar drive surfaces of the anti-rotation element preferably each adjoin the convex abutment surface and are arranged opposite to one another.

According to a further refinement of the dental implant on, the cylindrical or conical inner lateral surface is directly adjacent to the frontal, upper end of the dental implant. However, direct adjacency of the cylindrical or conical lateral surface to the frontal, upper end of the dental implant is not necessarily required. The cylindrical or conical internal lateral surface may be arranged above the internal thread arranged in the dental implant. Thus, the internal thread is at a greater distance from the frontal, upper end of the dental implant than the cylindrical or conical inner lateral surface.

Similar to the corresponding lateral surface of the superstructure, the cylindrical or conical inner lateral surface arranged on the dental implant is preferably symmetrical about the longitudinal axis, except for the anti-rotation element.

The anti-rotation element, similar to the recess arranged on the superstructure, is preferably mirror-symmetrical to a longitudinal sectional plane in which the longitudinal axis lies and which divides the anti-rotation element into two halves of equal size. The anti-rotation element is thus preferably mirror-symmetrical with respect to this longitudinal sectional plane.

According to a further refinement of the dental, the interface has an outer lateral surface arranged in the region of the front end, wherein the outer lateral surface is oriented transversely to the longitudinal axis, surrounds the opening and is annular when viewed in a plan view along the longitudinal axis. This outer lateral surface is preferably configured conically. Preferably, it does not serve as an abutment surface with which the superstructure abuts the dental implant, but rather forms a free outer surface of the dental implant which surrounds the superstructure or the extension of the superstructure without touching the latter. Preferably, this outer lateral surface is directly adjacent at its upper end to an upper end of the cylindrical or conical inner lateral surface arranged within the opening located in the dental implant.

According to a third aspect, a dental prosthesis is presented, comprising the superstructure and the dental implant. The dental prosthesis further comprises a fastening element for fastening the superstructure to the dental implant. This fastening element may be a screw which engages in the internal thread of the dental implant.

It is understood that the above features, and those to be explained below, may be used not only in the combination indicated in each case, but also in other combinations or alone, without departing from the spirit and scope of the present disclosure.

### BRIEF DESCRIPTION OF THE DRAWINGS

FIG. 1 shows a perspective view of a first embodiment of the dental implant;

FIG. 2 shows a longitudinal sectional view of the first embodiment of the dental implant shown in FIG. 1;

FIG. 3 shows a top view of the embodiment of the dental implant shown in FIG. 1;

FIG. 4 shows a perspective view of a first embodiment of the superstructure;

FIG. 5 shows a plan view from below of the first embodiment of the superstructure shown in FIG. 4;

FIG. 6 shows a longitudinal sectional view of a dental prosthesis, with the dental implant and the superstructure according to the first embodiment;

FIG. 7 shows a perspective view of a second embodiment of the dental implant;

FIG. 8 shows a longitudinal sectional view of the second embodiment of the dental implant shown in FIG. 7;

FIG. 9 shows a top view of the second embodiment of the dental implant shown in FIG. 7;

FIG. 10 shows a perspective view of a second embodiment of the superstructure;

FIG. 11 shows a plan view from below of the second embodiment of the superstructure shown in FIG. 10; and

FIG. 12 shows a longitudinal sectional view of a dental prosthesis with the dental implant and the superstructure according to the second embodiment.

### DESCRIPTION OF PREFERRED EMBODIMENTS

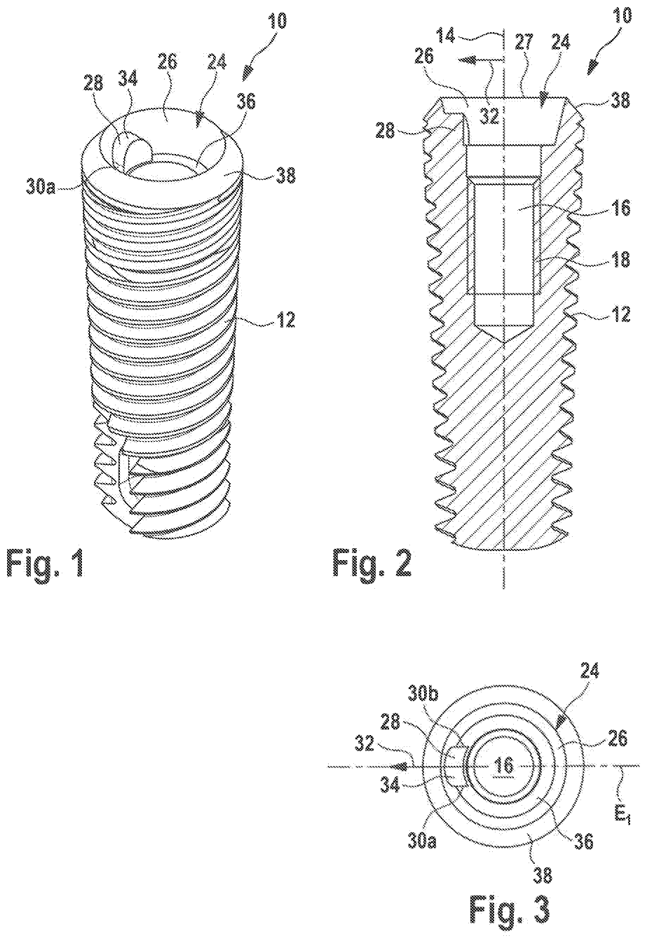

FIGS. 1-3 show a first embodiment of the dental implant in various views. The dental implant is designated therein in its entirety by reference numeral 10.

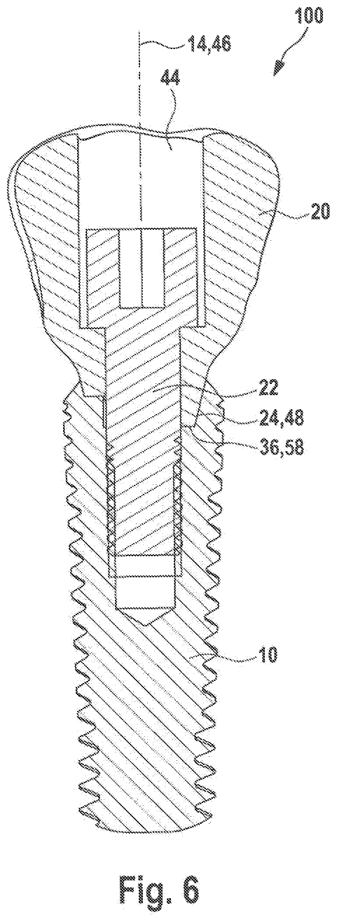

The dental implant 10 is typically made of titanium or zirconia. It comprises an external thread 12 on its outer surface, by means of which the dental implant 10 can be screwed into a jawbone of a patient. The dental implant 10 extends substantially along a longitudinal axis 14, which may also be drawn as a central axis. In its interior, the dental implant 10 comprises an opening 16 that extends along the longitudinal axis 14. Preferably, at least a portion of this opening 16 is configured as a bore, more preferably as a blind bore. An internal thread 18 is arranged in the opening 16. This internal thread 18 is used for fastening a superstructure 20 (artificial dental crown) to the dental implant 10. For fastening the superstructure 20 to the dental implant 10, preferably a screw 22 is used which engages in the internal thread 18 (see FIG. 6).

At the frontal, upper end, the dental implant 10 comprises an interface 24, which is shown in FIG. 3 in a top view from above. This interface 24 serves to attach the superstructure 20 to the dental implant 10. The interface 24 forms, so to speak, the abutment area with which the dental implant 10 abuts the superstructure 20 in the assembled state of the dental prosthesis 100.

The unique feature of the interface 24 is that, due to its shape and construction, it allows the superstructure to be attached directly to the dental implant 10 (without the use of an interposed abutment).

The interface 24 comprises an inner lateral surface 26 arranged within the opening 16. This inner lateral surface 26 at least partially surrounds the longitudinal axis 14 and preferably directly adjoins an upper, front end 27 of the dental implant 10. In the first embodiment shown in FIGS. 1-3, the inner lateral surface 26 is configured as a conical lateral surface that is rotationally symmetrical about the longitudinal axis 14.

The interface 24 further comprises an anti-rotation element 28. In the assembled state of the dental prosthesis 100, this anti-rotation element 28 prevents the superstructure 20 from rotating relative to the dental implant 10. The anti-rotation element 28 protrudes radially inwardly from the inner lateral surface 26.

In the herein shown embodiment, the anti-rotation element 28 is integrally connected to the dental implant 10. In principle, however, anti-rotation element 28 can also be configured as a separate component that is fastened in the dental implant 10.

The anti-rotation element 28 comprises two drive surfaces 30a, 30b that are arranged opposite to one another. These two drive surfaces 30a, 30b are arranged on opposite sides of the anti-rotation element 28. The drive surfaces 30a, 30b are each configured as planar surfaces. Preferably, both planar drive surfaces 30a, 30b extend parallel to a radial direction 32 that is oriented orthogonally to the longitudinal axis 14. Said radial direction 32 is drawn as an arrow in FIGS. 2 and 3, respectively. An imaginary longitudinal sectional plane E₁ spanned by said radial direction 32 and said longitudinal axis 14 divides said anti-rotation element 28 into two equal halves. The anti-rotation element 28 is preferably mirror-symmetrical with respect to this longitudinal sectional plane E₁.

The drive surfaces 30a, 30b serve as abutment surfaces for corresponding mating surfaces arranged on the superstructure and will be explained in detail below. The drive surfaces 30a, 30b essentially serve to absorb a torque acting about the longitudinal axis 14 between the superstructure 20 and the dental implant 10. They prevent rotation of the superstructure 20 relative to the dental implant 10 about the longitudinal axis 14. Due to the described arrangement of the drive surfaces 30a, 30b, they absorb forces acting substantially in the circumferential direction.

Furthermore, the anti-rotation element 28 comprises a convex abutment surface 34. This convex abutment surface 34 forms an upper side of the anti-rotation element 28 facing the frontal upper end 27 of the dental implant 10. The convex abutment surface 34 extends substantially parallel to the radial direction 32, and is also symmetrical with respect to the imaginary longitudinal sectional plane E₁.

The planar drive surfaces 30a, 30b are adjacent the convex abutment surface 34 on opposite sides thereof. The first drive surface 30a is adjacent a first end of the convex abutment surface 34, and the second drive surface 30b is adjacent an opposite, second end of the convex abutment surface 34.

The convex abutment surface 34 serves as an abutment surface for a corresponding concave mating surface arranged on the superstructure 20, described in detail below. Forces parallel to the longitudinal axis 14 are essentially absorbed by the convex abutment surface 34. However, due to its convex shape, forces transverse thereto can be transmitted via the convex abutment surface 34 as well.

Inside the opening 16, the dental implant 10 further comprises an annular bearing surface 36. In the herein shown embodiment, this annular bearing surface 36 is locally arranged between the conical inner lateral surface 26 and the internal thread 18. It is directly adjacent to the conical inner lateral surface 26 and is oriented transversely, preferably orthogonally, to the longitudinal axis 14.

The annular bearing surface 36 can serve as an axial bearing surface for the superstructure 20, and accordingly can absorb forces parallel to the longitudinal axis 14. As can be seen from FIG. 6, in the assembled state of the dental prosthesis 100, it bears against a corresponding mating surface of the superstructure, which will be explained in detail below.

It should be noted, however, that the axial abutment of the superstructure 20 against the dental implant 10 does not necessarily need to be against the annular abutment surface 36. In particular, in the case of the convex design of the inner lateral surface 26, the inner lateral surface 26 can also serve as both a radial and axial abutment surface for the superstructure 20.

The dental implant 10 further comprises an outer lateral surface 38 disposed in the region of the front end 27. This outer lateral surface 38 is oriented transversely to the longitudinal axis 14. It surrounds the opening 16 and, in the present embodiment, is conical in shape. When viewed in a plan view along the longitudinal axis 14, the conical outer lateral surface 34 is circular. As can be seen from FIG. 6, this outer lateral surface 38 forms an outer surface of the dental implant 10, which preferably does not abut the superstructure 20. In the herein shown embodiment, the outer lateral surface 38 is directly adjacent to the conical inner lateral surface 26 at the front end 27 of the dental implant 10.

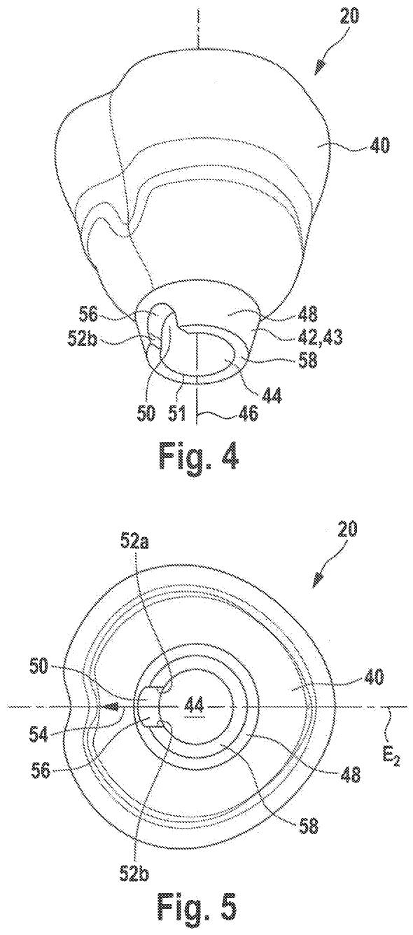

FIGS. 4 and 5 show a first embodiment of the superstructure 20, which serves as a counterpart to the dental implant 10 shown in FIGS. 1-3. The superstructure 20 comprises an artificial denture 40, which is illustrated here as an artificial dental crown. An interface 42 is arranged on the lower side of this artificial dental crown 40, which serves to connect to the dental implant 10. The interface 42 is configured as an extension 43 that projects downwardly from the lower side of the artificial dental crown 40. This extension 43 forming the interface 42 is configured as a corresponding counterpart to the interface 24 arranged on the dental implant 10.

Internally, the superstructure 20 comprises an opening 44 which is preferably configured as a through hole. This opening 44 is closed at the upper, front end of the artificial dental crown 40 after the dental prosthesis 100 is mounted on the patient. The opening 44 extends substantially along a longitudinal axis 46 of the superstructure 20, which longitudinal axis 46 of the superstructure 20 coincides with the longitudinal axis 14 of the dental implant 10 in the mounted state of the dental prosthesis 100 (see FIG. 6).

The interface 42 provided on the superstructure 20 comprises a lateral surface 48 that forms an outer surface of the interface 42 and circumferentially surrounds the opening 44. In the first embodiment shown in FIGS. 4 and 5, the lateral surface 48 is configured conical as a counterpart to the inner lateral surface 26 provided on the dental implant 10.

Further, the interface 42 comprises a recess 50 formed laterally in the extension 43 forming the interface 42. The recess 50 serves as a counterpart to the anti-rotation element 28. In the assembled state of the dental prosthesis 100, the anti-rotation element 28 engages this recess 50.

The recess 50 is open towards the bottom. Accordingly, it does not have a closed contour, but is open on one side towards the lower end 51 of the interface 42. The cross-section of the recess 50 is preferably U-shaped (i.e. the shape of an upside-down U). Accordingly, it can also be described as a tunnel-like recess without a bottom surface.

The recess 50 passes through the side wall of the extension 43 forming the interface 42, thus interrupting the lateral surface 48 and opening into the opening 44 extending inside the superstructure 20.

The recess 50 comprises, as counterparts to the two drive surfaces 30a, 30b, two drive surfaces 52a, 52b facing each other. The drive surfaces 52a, 52b extend, similarly to the drive surfaces 30a, 30b, parallel to each other and preferably parallel to a radial direction 54 that is oriented orthogonally to the longitudinal axis 46 of the super-structure 20. In the assembled state of the dental prosthesis 100, the drive surface 52a abuts the drive surface 30a. Similarly, the drive surface 52b then abuts the drive surface 30b.

As a counterpart to the convex abutment surface 34 arranged on the anti-rotation element 28, the recess 50 comprises a concave abutment surface 56. This concave abutment surface 56 is preferably configured as a cylindrical surface, the cross-section of which is semicircular.

The concave abutment surface 56 adjoins the planar drive surface 52b on a first side and adjoins the planar drive surface 52a on a second, opposite side. Similar to the shape of the drive element 28, this results in a shape of the recess 50 that is mirror symmetrical to a longitudinal section plane E₂ spanned by the radial direction 54 and the longitudinal axis 46

Apart from the recess 50, the interface 42 is (rotationally) symmetrical with respect to the longitudinal axis 46. Accordingly, the opening 44 preferably extends centrally through the extension 43 forming the interface 42. Thus, the entire interface 42 is preferably mirror-symmetrical with respect to the longitudinal sectional plane E₂ as well (see FIG. 5).

At its lower, front end 51, the interface 42 comprises an annular support surface 58. This annular support surface 58 serves as a counterpart to the annular support surface 36 arranged on the dental implant 10. The annular support surface 58 does not form a closed annulus, since it is interrupted by the recess 50. It therefore only forms a circular ring segment.

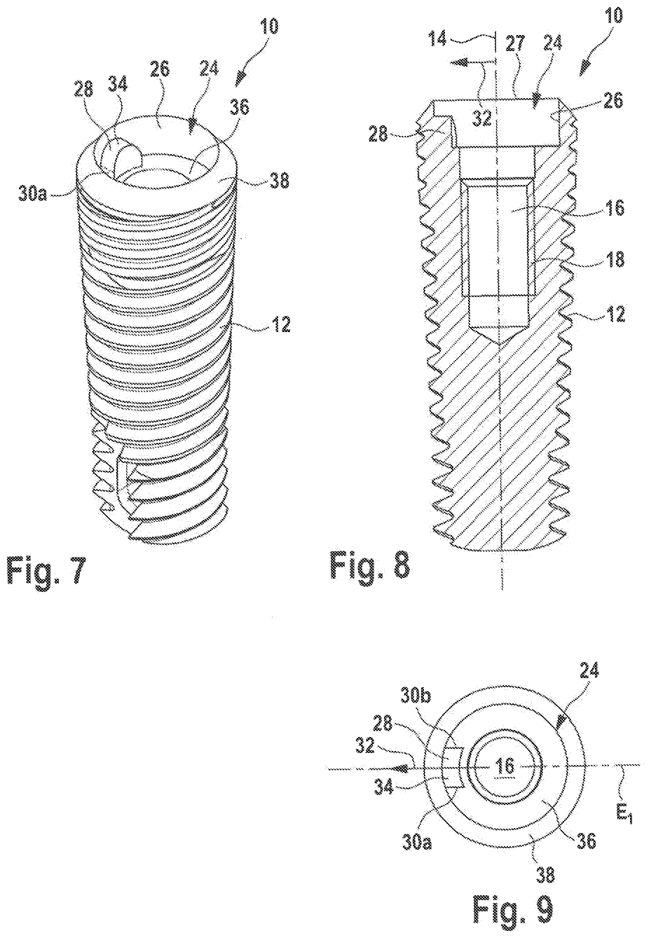

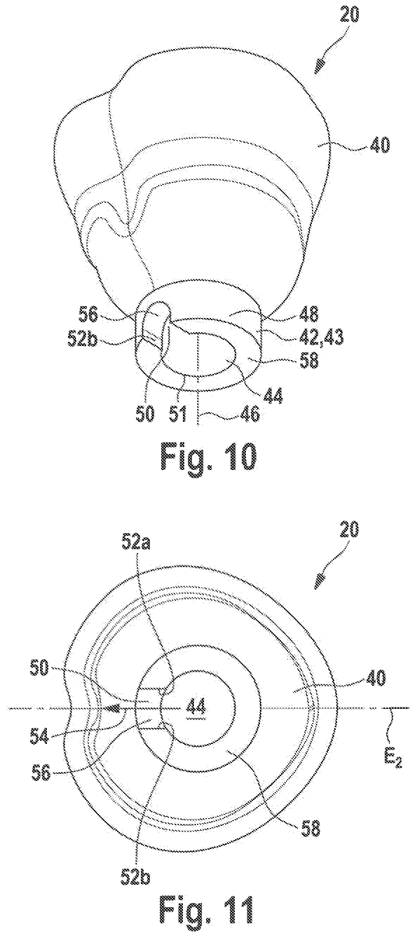

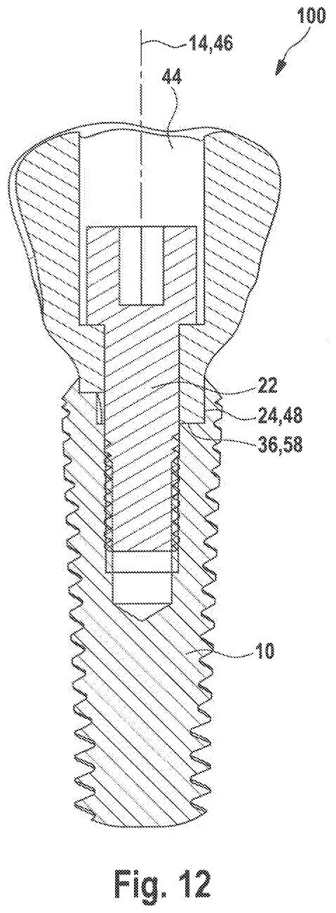

FIGS. 7-12 show a second embodiment of the dental implant 10 (FIGS. 7-9), of the superstructure 20 (FIGS. 10 and 11) and of the dental prosthesis 100 (FIG. 12). Identical or corresponding components are identified therein with the same reference numerals as before. The basic structure of the dental implant 10 and of the superstructure 20 according to the second embodiment is substantially the same as that of the first embodiment shown in FIGS. 1-6. The main difference of the second embodiment is that the inner lateral surface 26 arranged on the dental implant 10 and the outer lateral surface 48 arranged on the superstructure 20 are not concave, but cylindrical in shape. Accordingly, the annular bearing surfaces 36, 58 at which the superstructure 20 axially bears against the dental implant 10 are of comparatively larger configuration. However, the latter does not necessarily need to be the case. In principle, a somewhat smaller design of the annular bearing surfaces 36, 58 is also sufficient in the case of cylindrical lateral surfaces 24, 48.

Finally, it should be noted that the two embodiments of the dental implant 10, the superstructure 20 and the dental prosthesis 100 shown herein represent only two of many possible embodiments. It will be understood that various features of these two embodiments can be modified without departing from the spirit and scope of this disclosure. Similarly, it is understood that the two embodiments can also be combined without departing from the spirit and scope of this disclosure. For example, one portion of each of the lateral surfaces 24, 48 could be cylindrical in shape and another portion could be conical in shape.

What is claimed is:

1. A superstructure, comprising:
an opening extending along a longitudinal axis of the superstructure; and
an interface configured for attaching the superstructure to a dental implant;
wherein the interface comprises as an extension disposed on a lower side of the superstructure, surrounding the opening and having a cylindrical or conical lateral surface that forms an outer surface of the extension, and
wherein the lateral surface is interrupted by a recess that opens into the opening.

2. The superstructure according to claim 1, wherein the recess is arranged at a lower free end of the extension, and wherein the recess is open on its lower side toward the lower free end.

3. The superstructure according to claim 1, wherein the recess is a tunnel-like recess.

4. The superstructure according to claim 1, wherein the recess comprises two planar drive surfaces extending parallel to each other.

5. The superstructure according to claim 4, wherein each of the two planar drive surfaces extends parallel to a radial direction that is oriented orthogonally to the longitudinal axis.

6. The superstructure according to claim 1, wherein the recess comprises a concave abutment surface.

7. The superstructure according to claim 6, wherein the concave abutment surface extends parallel to a radial direction that is oriented orthogonally to the longitudinal axis.

8. The superstructure according to claim 4, wherein the concave abutment surface extends parallel to a radial direction that is oriented orthogonally to the longitudinal axis, and wherein the planar drive surfaces each adjoin the concave abutment surface and are arranged opposite to one another.

9. The superstructure according to claim 1, wherein the opening extends centrally through the extension.

10. The superstructure according to claim 1, wherein the lateral surface is, except for the recess, symmetrical about the longitudinal axis.

11. The superstructure according to claim 1, wherein the extension is mirror-symmetrical to a longitudinal sectional plane in which the longitudinal axis lies and which divides the recess into two equal halves.

12. The superstructure according to claim 1, wherein the extension comprises at its lower free end an annular bearing surface that is interrupted by the recess and oriented transversely to the longitudinal axis.

13. The superstructure according to claim 1, wherein the superstructure comprises an artificial denture that is integrally connected to the interface, wherein the opening extends through the extension into the artificial denture.

14. A dental implant, comprising:
an external thread arranged on an outer side of the dental implant;
an opening extending along a longitudinal axis of the dental implant, in which an internal thread is arranged; and
an interface configured for attaching a superstructure to the dental implant,
wherein the interface is arranged in a region of a front end of the dental implant;
wherein the interface comprises a cylindrical or conical inner lateral surface arranged in the opening, at least partially surrounding the longitudinal axis and interrupted by an anti-rotation element that is configured to prevent rotation of the superstructure about the longitudinal axis relative to the dental implant, wherein the anti-rotation element projects radially inwards from the inner lateral surface.

15. The dental implant according to claim 14, wherein the anti-rotation element comprises two planar drive surfaces extending parallel to each other.

16. The dental implant according to claim 15, wherein each of the two planar drive surfaces extends parallel to a radial direction that is oriented orthogonally to the longitudinal axis.

17. The dental implant according to claim 14, wherein the anti-rotation element comprises a convex abutment surface.

18. The dental implant according to claim 17, wherein the convex abutment surface extends parallel to a radial direction that is oriented orthogonally to the longitudinal axis.

19. The dental implant according to claim 15, wherein the convex abutment surface extends parallel to a radial direction that is oriented orthogonally to the longitudinal axis, and wherein the planar drive surfaces each adjoin the convex abutment surface and are arranged opposite to one another.

20. The dental implant according to claim 14, wherein the cylindrical or conical inner lateral surface is directly adjacent the front end of the dental implant.

21. Dental implant according to claim 14, wherein the cylindrical or conical inner lateral surface is, except for the anti-rotation element, symmetrical about the longitudinal axis.

22. The dental implant according to claim 14, wherein the anti-rotation element is mirror-symmetrical to a longitudinal sectional plane in which the longitudinal axis lies and which divides the anti-rotation element into two equal halves.

23. The dental implant according to claim 14, wherein the interface has an outer lateral surface arranged in the region of the front end, wherein the outer lateral surface is oriented transversely to the longitudinal axis, surrounds the opening and is annular when viewed in a plan view along the longitudinal axis.

24. The dental implant of claim 23, wherein the outer lateral surface is conical.

25. A dental prosthesis, comprising:
a superstructure having an opening extending along a longitudinal axis of the superstructure, and having an interface configured for attaching the superstructure to a dental implant, wherein the interface comprises as an extension disposed on a lower side of the superstructure, surrounding the opening and having a cylindrical or conical lateral surface that forms an outer surface of the extension, and wherein the lateral surface is interrupted by a recess that opens into the opening;
a dental implant, having an external thread arranged on an outer side of the dental implant, having an implant opening extending along a longitudinal axis of the dental implant, in which an internal thread is arranged; and having an implant interface configured for attaching the superstructure to the dental implant, wherein the implant interface is arranged in a region of a front end of the dental implant, wherein the implant interface comprises a cylindrical or conical inner lateral surface arranged in the opening, at least partially surrounding the longitudinal axis of the dental implant and interrupted by an anti-rotation element that is configured to prevent rotation of the superstructure relative to the dental implant about the longitudinal axis of the dental implant, wherein the anti-rotation element projects radially inwards from the inner lateral surface; and
a fastening element configured to fasten the superstructure to the dental implant.
